(19) United States
(12) Patent Application Publication
(10) Pub. No.: US 2005/0039024 A1
(43) Pub. Date: Feb. 17, 2005

(54) System and method for engine compartment optimization

(76) Inventors: Michael Stemm, Lapeer, MI (US); Jonathan P. Grasso, Clinton Twp., MI (US); Perry Palanca, White Lake, MI (US)

Correspondence Address: HARNESS, DICKEY & PIERCE, P.L.C., P.O. BOX 828, BLOOMFIELD HILLS, MI, 48303, US

(21) Appl. No.: 10/817,372

(22) Filed: Apr. 2, 2004

Related U.S. Application Data
(60) Provisional application No. 60/459,916, filed on Apr. 3, 2003.

(51) Int. Cl. H04K 1/00

(52) U.S. Cl. 713/182

(57) ABSTRACT

A system for engine compartment optimization includes a shared wall assembly for housing a plurality of functional components of a motor vehicle. The shared wall assembly includes a main body portion partially defining first, second and third chambers. The main body portion includes a first shared wall disposed between the first and second chambers and a second shared wall disposed between the second and third chambers. The shared wall assembly further includes an upper unit for further defining at least two of the first, second and third chambers, the cover member removable attached to the main body portion.

### CROSS-REFERENCE TO RELATED APPLICATIONS

This application claims the benefit of U.S. Provisional Application No. 60/459,916, filed on Apr. 3, 2003. The disclosure of the above application is incorporated herein by reference as if fully set forth herein.

### FIELD OF THE INVENTION

The present invention generally pertains to motor vehicles. More particular, the present invention pertains to a system and method for engine compartment optimization.

### BACKGROUND OF THE INVENTION

In automotive applications, it is imperative that fluids and electrical power are reliably provided to an engine and other moving parts of a vehicle to ensure that the operation of the vehicle is enabled and maintained. Further, it is desirable that a vehicle underhood system be capable of accommodating varying requirements, such as component packaging and the like. It is desirable that underhood component packaging be efficient to install and aesthetically pleasing. For these and other competing reasons, the packaging of underhood components of a vehicle plays a significant role in vehicle design.

Supplying the various fluids and power to the components of a vehicle is crucial in its design, operation and maintenance. For example, it is highly desirable to provide a vehicle with an uncluttered and otherwise pleasing appearance. The underhood systems must also be efficiently assembled and provide the necessary maintenance access to the various components.

Typically, the various components of a vehicle for fluid and electrical power delivery are individually mounted at varying locations within the engine compartment. In this manner, the aforementioned components are scattered throughout the engine compartment and require multiple fasteners and varying assembly locations.

While it remains a goal to provide a vehicle underhood system that is efficient to install and aesthetically pleasing, it is also a goal to provide a vehicle underhood system that may be easily adapted for use across vehicle lines. As a result, a common underhood system incorporating predetermined components may be used across vehicle lines for two or more distinct vehicles. When incorporating common components across vehicle lines it is sometimes desirable to provide markings for brand differentiation.

Accordingly, a continued need for improvement in the pertinent art exists.

### SUMMARY OF THE INVENTION

In one embodiment, the present invention provides a shared wall assembly for housing a plurality of functional components of a motor vehicle. The shared wall assembly includes a main body portion partially defining first, second and third chambers. The main body portion includes a first shared wall disposed between the first and second chambers and a second shared wall disposed between the second and third chambers. The shared wall assembly further includes an upper unit for further defining at least two of the first, second and third chambers, the cover member removable attached to the main body portion.

An underhood mounting system for mounting a plurality of underhood components including a battery to a motor vehicle includes an integrally formed receiver member. The integrally formed receiver member defines a plurality of dedicated locations for receiving a corresponding plurality of underhood components and is adapted for attachment to the body of the vehicle. A first dedicated location of the plurality of dedicated locations defines a portion of a battery chamber. A cover member is operable to cooperate with the first dedicated location to define a remainder of the battery chamber, the cover member defines a projection portion for engaging the battery and maintaining the battery in a secure relationship with the battery chamber in an assembled position.

According to other features, the cover member defines an upper portion for covering a top face of the battery and a forward portion for covering a forward face of the battery. The forward portion incorporates the projection portion thereon. A coupling member is adapted to selectively secure the cover member to the first dedicated location of the receiver member. The coupling member is operable to locate the cover member in a position relative to the first dedicated location of the receiver member whereby the projection portion is influenced into the battery for maintaining the battery in the secure relationship with the battery chamber.

According to yet other features, an underhood mounting system for a vehicle includes an engine cover defining an opening on an upper surface. The opening provides access to a throttle body. A throttle body access covers the opening in an installed position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top view of a system for engine compartment optimization constructed in accordance with the teachings of an embodiment of the present invention, the system shown operatively associated with a motor vehicle;

FIG. 2 is a perspective view of the system for engine compartment optimization and motor vehicle of FIG. 1;

FIG. 3 is an exploded view of the system for engine compartment optimization of FIG. 1;

FIG. 4A is an exploded view similar to FIG. 3, illustrating the components of the system for engine compartment optimization of FIG. 1 exploded according to their shipping condition;

FIG. 4B is an exploded view of a plurality of throttle body access panels for cooperating with an engine resonator according to the present invention;

FIG. 5 is an exploded view of the driver side components of the system for engine compartment optimization of the present invention;

FIG. 6 is an exploded view of the passenger side components of the system for engine compartment optimization of the present invention;

FIG. 7 is an exploded view of the driver side components of the system for engine compartment optimization according to additional features of the present invention; and

FIG. 8 is a sectional view of the driver side components of FIG. 7 shown in an assembled position and housing a battery.

### DETAILED DESCRIPTION

The following description is merely exemplary in nature and is in no way intended to limit the invention, its application, or uses.

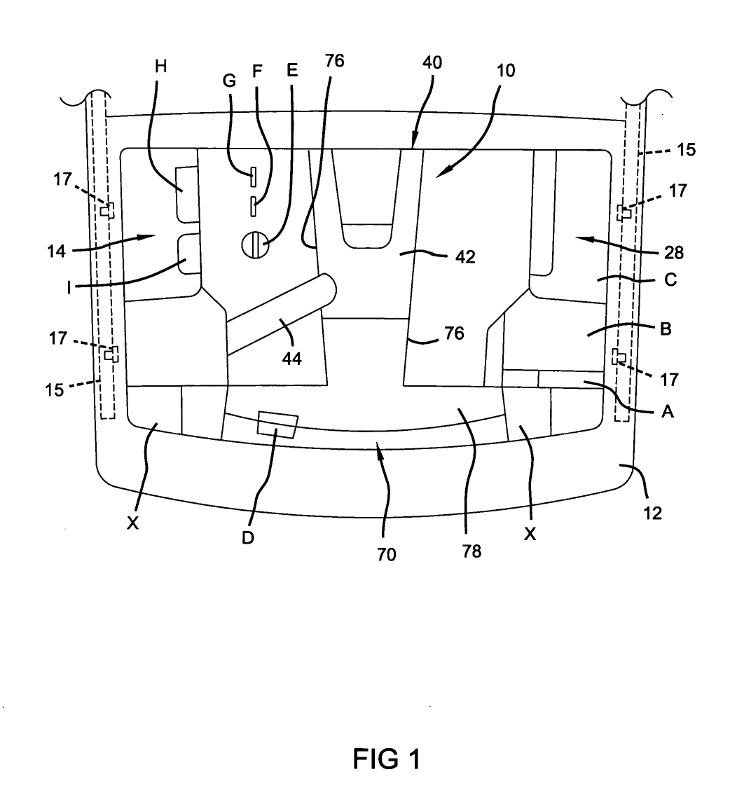

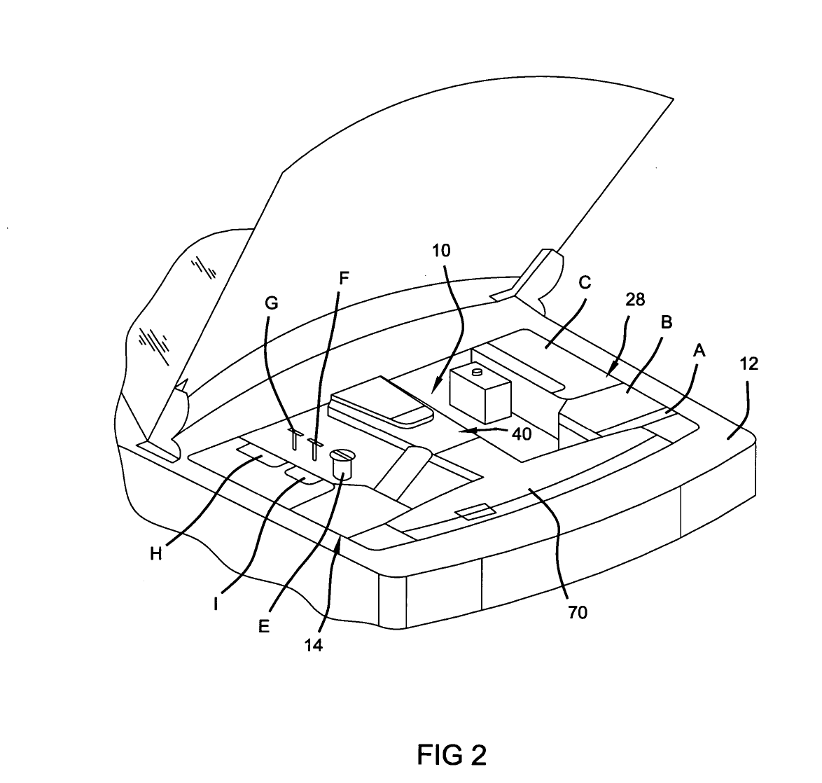

With initial reference to FIGS. 1 and 2, a system for engine compartment optimization constructed in accordance with the teachings of the present invention is illustrated and generally identified at reference number 10. The system for engine compartment optimization 10 is shown operatively installed within an exemplary motor vehicle 12. The vehicle illustrated in a light duty truck 12. Those skilled in the art, however, will appreciate that the teachings of the present invention are not so limited.

As will become more apparent below, the system for engine compartment optimization 10 of the present invention retains the following access locations associated with conventional vehicles: washer bottle access (A); battery access (B); fuseblock access (C), remote jump point access (D); oil fill access (E); oil dip stick access (F); transmission dip stick access (G); secondary battery access (H); and coolant bottle access (I). The system 10 includes a number of plastic components which contribute to an aesthetically pleasing underhood while retaining the required functionality and accessibility of conventional underhood elements. The system 10 further operates to reduce part and fastener count and also reduce the number of shipped assemblies.

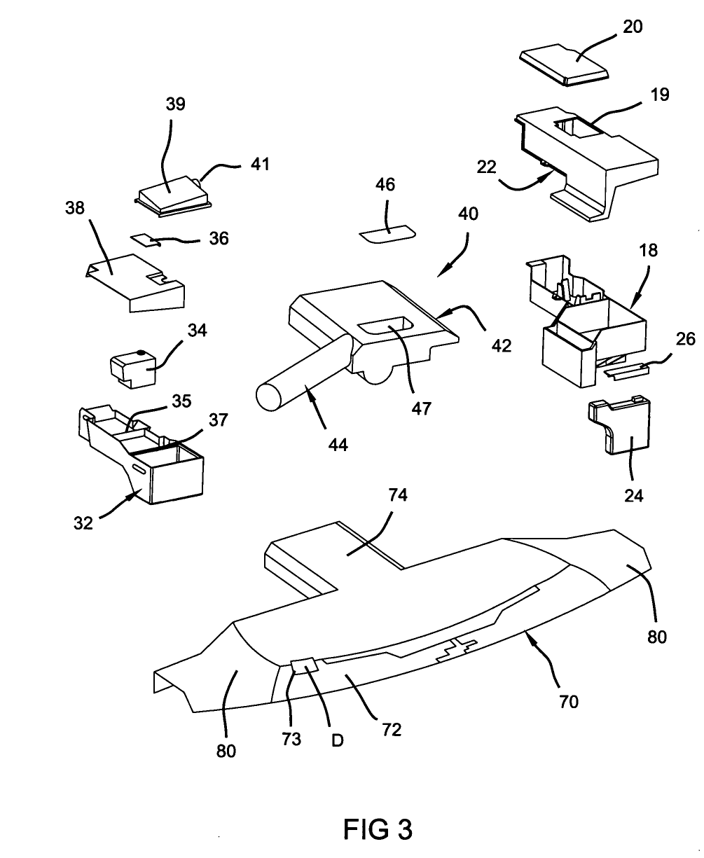

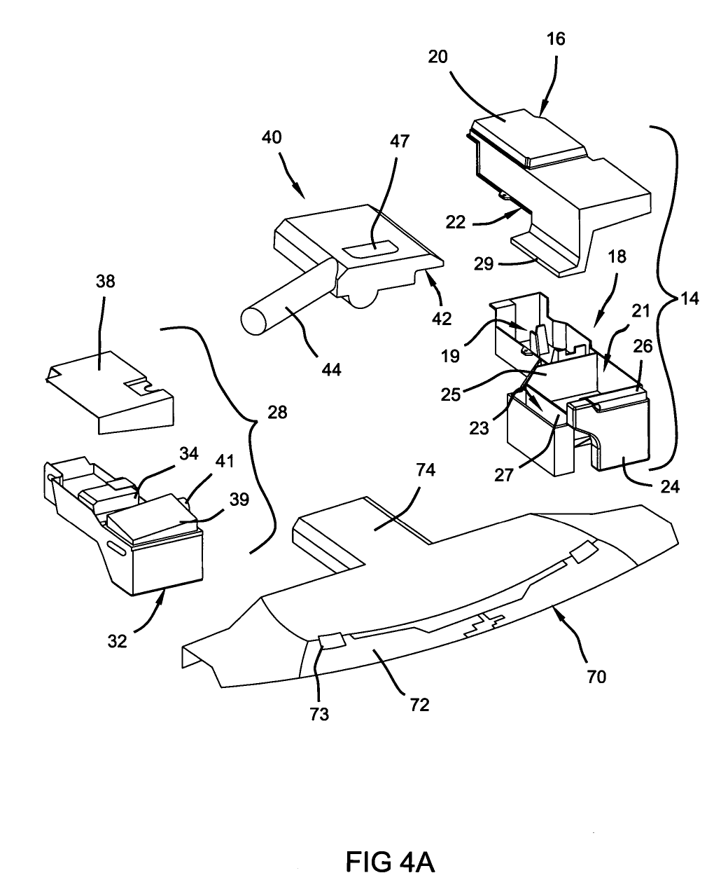

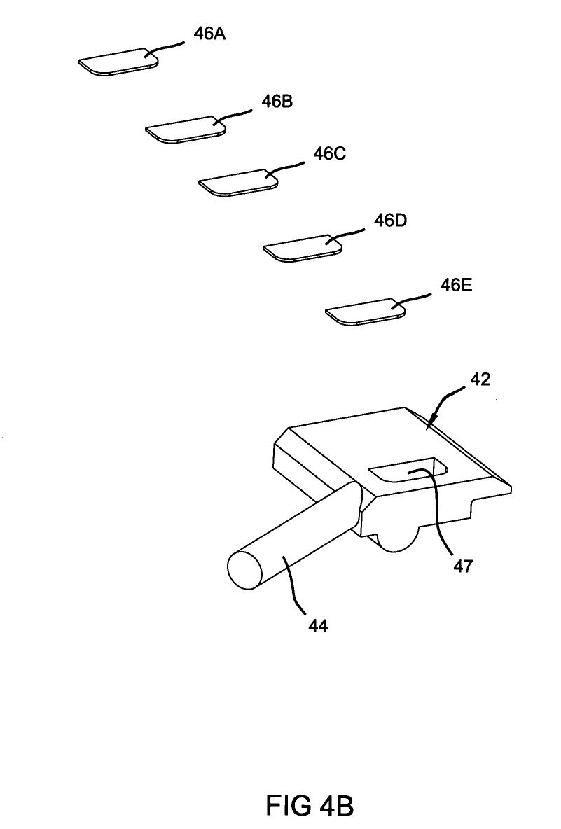

With continued references to FIGS. 1 and 2 and additional reference to the exploded views of FIGS. 3 and 4, the various components of the system for engine compartment optimization 10 of the present invention will be further described. More particularly, FIG. 3 illustrates the system 10 with each of the components exploded from one another. FIG. 4 illustrates the components exploded into units as may be shipped to a final vehicle assembly location. Each of the components shown in FIGS. 3 and 4 is preferably injection molded of a plastic.

The system 10 is generally illustrated to include a first side assembly 14. In the embodiment illustrated, the first side assembly 14 is a driver side assembly. As used herein, the term “driver side” is intended to reference a right side of the vehicle 12 (as viewed from the front of the vehicle 12). The driver side assembly 14 is secured to a chassis 15 of the vehicle 12. In this regard, a plurality of fasteners 17 as shown in FIG. 1 securing the first side assembly 14 to the chassis 15. In one application, the first side assembly 14 may be fastened to hydroformed rails of the chassis 15. The rails 15 of the vehicle 12 will be understood to be of conventional construction insofar as the present invention is concerned.

The driver side assembly 14 is illustrated to generally include an upper unit 16 and a lower unit 18. As will become more apparent, the upper unit 16 and the lower unit 18 cooperate to define a plurality of shared-wall chambers. The upper unit 16 includes a main body portion 22 that is secured to the lower unit 18 with fasteners not particularly shown. The upper unit 16 further includes a panel 20 that is snap fit to the main body portion 22 and provides access to an opening 19 in an upper surface of the main body portion 22.

The lower unit 18 of the driver side assembly 14 is integrally formed. In the embodiment illustrated, the lower unit 18 is formed to define a lower portion at least partially defining three chambers. Specifically, the lower unit 18 defines a fuseblock lower 19, a battery tray 21 and an ECM carrier 23. A first shared wall 25 is located between the first chamber and the second chamber. A second shared wall 27 is located between the second chamber and the third chamber. In the embodiment illustrated, the first and second shared walls 25 and 27 are generally perpendicular to one another. A downwardly stepped portion 29 of the upper unit 16 defines a flange that covers an opening of the ECM carrier chamber 23. As should now be apparent, the upper unit 16 cooperates with the lower unit 18 to define distinct chambers for the ECM, battery and fuseblock.

A washer bottle 24 may be carried by the lower unit 18 and is associated with a washer bottle cap 26. The washer bottle 24 is secured to a side of the lower unit 18 in a conventional manner. In this regard, the washer bottle 24 may be bolted, attached with integrally formed hooks, or otherwise securely fastened to the lower unit 18. In some applications, it may be desirable to integrally form the water bottle 24 with the lower unit 18. Integration of the washer bottle 24 with the lower unit 18 facilitates final vehicle assembly by reducing the number of discrete parts for assembly.

As perhaps most clearly depicted in the perspective view of FIG. 2, the upper surfaces of the first side assembly 14 cooperate to define one or more planar surfaces that contribute to a clean and aesthetically pleasing appearance. The cap 26 of the water bottle 24 similarly defines a planar surface. More specifically with respect to the exemplary embodiment, the cap 26 and the main body portion 22 define planar upper surfaces generally in the same plane. The upper surface of the panel 16 is slightly raised with respect to but parallel to this common plane. In one application, the one or more planar surfaces defined by the first side assembly provide a substantially continuous surface that extends substantially along the length of the engine compartment (e.g. between a cowl area of the vehicle 12 to the sight shield 70).

The system for engine compartment optimization 10 further includes a second side assembly 28. In the embodiment illustrated, the second side assembly 28 is a passenger side assembly. As used herein, the term “passenger side” is intended to reference a left side of the vehicle 12 (as viewed from the front of the vehicle 12). The passenger side assembly 28 is similarly secured to the chassis 15 of the vehicle 12. As with the driver side assembly 14, this securement to the rail 15 is accomplished in a conventional manner insofar as the present invention is concerned. One suitable manner is with fasteners 17. In certain applications (e.g., where the second side assembly 28 incorporates an integrated air box), it may be desirable to shield the second side assembly 28 from the chassis with a gasket (not shown) or the like for the absorption of vibration.

The second side assembly 28 includes a main body portion 32 partially defining a plurality of chambers. In the embodiment illustrated, the main body portion 32 partially defines three chambers. A first chamber receives a second battery. A second chamber receives a coolant bottle 34. A third chamber is an air box chamber. A first shared wall 35 is disposed between the first chamber and the second chamber. A second shared wall 37 is disposed between the second chamber and the third chamber.

The second side assembly 28 additionally includes a common cover 38. The cover 38 cooperates with the main body portion 32 to define the first and second chambers. The cover 38 is second to the main body portion 32 with fasteners or in any other manner well known in the art. A panel 36 provides access to the washer bottle 34.

The second side assembly 28 further includes an air box cover 39. The air box cover 39 cooperates with the main body portion 32 to define the third chamber. The air box cover 39 includes a tubular input 41 in fluid communication with the third chamber.

As again shown most clearly in the perspective view of FIG. 2, the upper surfaces of the second side assembly 28 cooperate to define one or more planar surfaces that further contribute to the clean and aesthetically pleasing appearance of the vehicle underhood. More specifically, with respect to the exemplary embodiment, the covers 38 and 39 define a generally planar surface. This generally planar surface extends along a substantial portion of the length of the engine compartment between the cowl area and the sightshield 70.

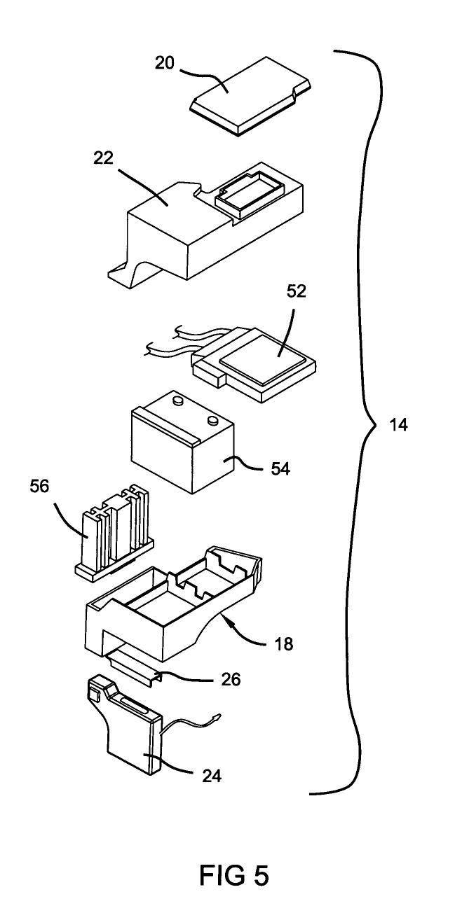

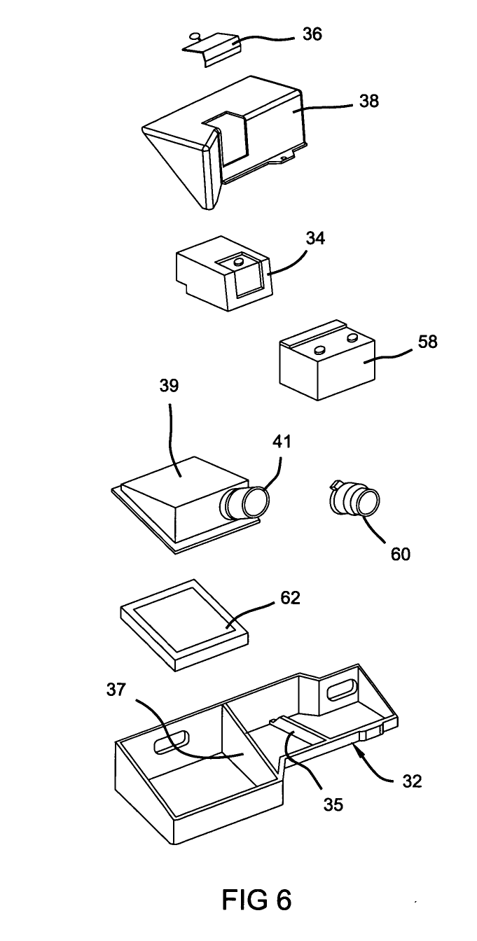

Turning to FIGS. 5 and 6, additional perspective views of the driver side assembly 14 and passenger side assembly 28 are shown. These exploded views further illustrate the various components of the system 10 of the present invention with their functional components. More particularly, FIG. 5 illustrates the components of the driver side assembly 14 with a conventional fuseblock 52, an auxiliary battery 54 and engine control module 56. FIG. 6 illustrates the various components of the passenger side assembly 28 with a primary battery 58, a manifold airflow (MAF) sensor, and an air filter 62.

The system for engine compartment optimization 10 is further shown to generally include a center assembly 40. The center assembly 40 is preferably blow molded of plastic. The center assembly 40 is illustrated to generally include an engine cover 42 and an engine resonator 44. The engine cover 42 defines an opening 47 that provides access to a throttle body (not particularly shown) of the engine. In this regard, the throttle body can be accessed without removing the cover 42. As particularly shown in FIG. 4A, a throttle body access panel 46 covers the opening 47 in the engine resonator 44. The resonator 44 is in fluid communication with the input 41.

The panel 46 is removably secured to the cover 42. In the embodiment illustrated, the panel 46 is snap fit to the cover 42. While not preferred for most applications, the panel 46 may be secured to the cover 42 with discrete fasteners.

With reference now to FIG. 4B, the present invention is illustrated to include a plurality of throttle body access panels 46A-46E. The panels 46A-46E may be individually selected for cooperating with the engine cover 42. The dimensions of the throttle body access panels 46A-46E are substantially equivalent, and as such, each may selectively engage the engine cover 42 around the opening 47 to form a cover thereat. The outer periphery of the access panels 46A-46E preferably forms a press-fit with the opening 47 defined in the cover 42 for securably locating a desired access panel 46A-46E with the cover 42. As discussed above, the throttle body access panel 46 may be removed from engagement with the cover 42 when access to the throttle body is desired, such as for maintenance.

In general, each of the plurality of throttle body access panels 46A-46E may include a unique marking D₁-D₅ thereon. For example, a vehicular nameplate, an engine configuration or other identifiers may be incorporated onto the access panels 46A-46E. In this way, a common engine cover 42 may be incorporated into distinct vehicles and include distinct badging. To provide product differentiation, or other identification, a unique throttle body access panel 46A-46E may be selected and affixed to the cover 42 at the opening 47.

With particular reference to FIGS. 1 and 2, the system 10 of the present invention is illustrated to include a remote powerpoint access D. More specifically, the sightshield 70 includes a hinged panel 73 that provides access to a powerpoint. The powerpoint is adapted to receive a plug-in connector or can alternatively receive the terminal ends of conventional jumper cables. In this regard, positive and negative terminal points are alternatively provided. The remote powerpoint access provides convenient access to the battery terminals for jumping.

The system for engine compartment optimization 10 is further shown to include a sightshield 70. The sightshield 70 is unitarily constructed of plastic. The sightshield 70 is illustrated to generally include a main body portion 72 that extends in a cross-car direction. The sightshield 70 further generally includes a longitudinally extending portion 74 that rearwardly extends from the main body portion 72. The sightshield 70 is secured to the vehicle with a plurality of fasteners (not specifically shown).

The sightshield 70 further contributes to the clean and aesthetically pleasing appearance of the underhood provided by the arrangement 10 of the present invention. In the embodiment illustrated, the longitudinally extending portion 74 is aligned with the engine cover 42. The longitudinally extending portion 74 cooperates with the engine cover 42 to define generally planar sides 66. In the embodiment illustrated, the sides 76 slightly diverge as they extend away from the main body portion 72.

The main body portion 74 defines a substantially planar central portion 78 (see FIG. 1). In the embodiment illustrated, the central portion 78 is raised above the planes defined by the upper surfaces of the side assemblies 14 and 288. Lateral sides 80 of the main body portion 70 downwardly transition from the central portion 78 to the planes defined by the upper surfaces of the side assemblies 14 and 28.

The sightshield 70 functions as a recirculation shield. In this regard, the configuration of the sightshield forces engine intake air to be drawn through the grille of the vehicle 12. Explaining further, the sightshield 70 prevents engine warmed air from being drawn back into the engine.

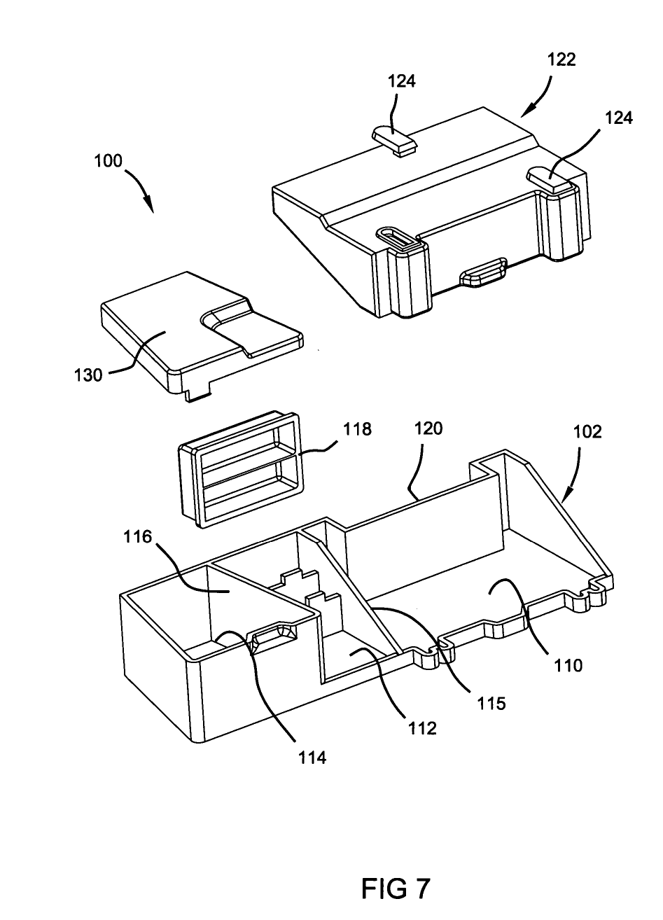

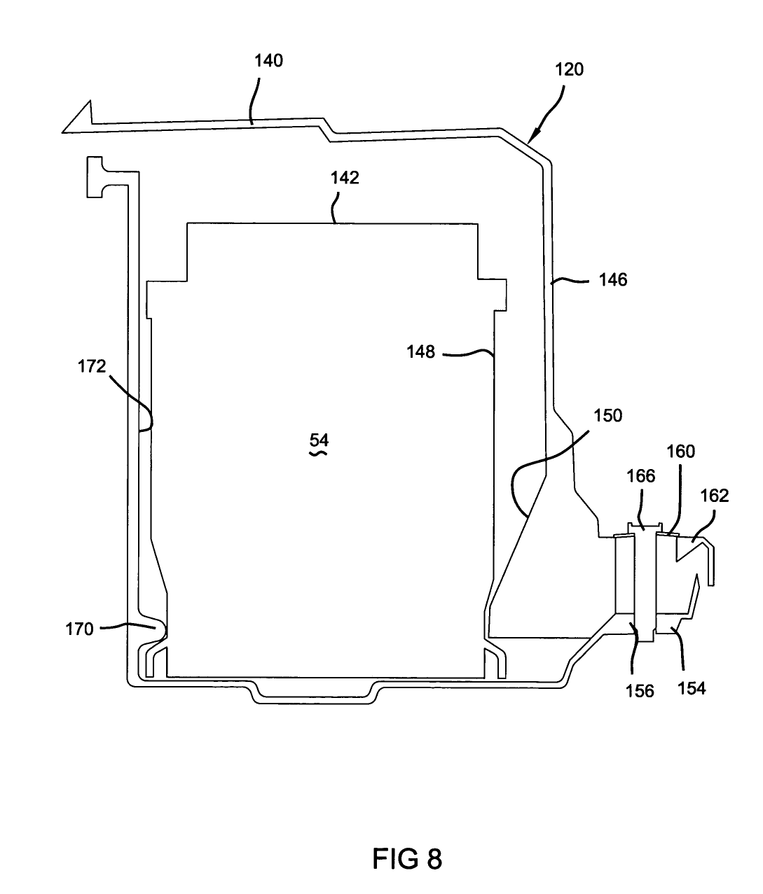

Turning now to FIGS. 7 and 8, a driver side assembly according to additional features of the present invention is shown and referred to generally at reference 100. The driver side assembly 100 generally includes an integrally formed receiver member or lower portion 102. The lower portion 102 partially defines first, second and third receiving portions or chambers 110, 112 and 114. A first shared wall 115 is disposed between the first and second chambers 110 and 112. A second shared wall 116 is disposed between the second chamber and the third chamber 112 and 114.

The receiving portions 110, 112 and 114 are adapted to each accept functional components thereat. In one example, the first receiving portion is a battery chamber 110 adapted to receive a battery (such as battery 54, FIG. 5). The second receiving portion 112 is adapted to receive an engine control module (e.g. engine control module 56, FIG. 5). The third receiving portion 114 is adapted to receive a conventional fuseblock (such as fuseblock 52 as depicted in FIG. 5). It is appreciated that other functional components may be adapted to be received in the respective receiving portions 110, 112 and 114. Additionally, although assembly 100 is described as being associated with the driver side, it may similarly be associated with the passenger side of the vehicle.

A vacuum reservoir 118 may be attached to the receiver member 102. In the embodiment illustrated, the vacuum breaker 118 is received in a recessed area 120 of a rear surface of the lower portion 102. The vacuum breaker 118 is attached with discrete fasteners (not shown) or in any other manner well known in the art.

The assembly 100 is shown to additionally include a first cover 122. The first cover cooperates with the lower portion 102 to define the first and second chambers 110 and 112. The cover 122 includes a pair of caps 124. The caps 124 are snap fit to the terminals of the battery.

The cover 120 generally defines an upper portion 140 for covering a top face 142 of the battery 54 and a forward portion 146 for covering a forward face 148 of the battery 54. The forward portion integrally incorporates a projection portion in the form of a wedge 150. In a manner that will become apparent, the wedge 150 is operable to maintain the battery 54 in a secure relationship with the lower portion 102 in the battery chamber 110.

The lower portion 102 includes a lower lip or flange 154 having a slot 156 for aligning with a complementary slot 160 formed on an upper lip 162 extending from the cover member 120. A coupling member 166 passes through the respective slots 156 and 160 formed on the lower portion 102 and the cover member 120 in an assembled position (as shown in FIG. 8). Upon engagement of the coupling member 166 with the receiver member 102 and the cover member 120, the wedge portion 150 is influenced into an engaged relationship with the battery 54. Specifically, the battery 54 is maintained in a secure relationship between the wedge portion 150 and a rear finger portion 170 extending from a rear face 172 of the battery chamber 110.

The assembly 100 is further shown to include a second cover 130. The second cover 130 cooperates with the lower portion 102 to define the third chamber 114. In the embodiment illustrated, the cover 130 is snap fit to the lower portion 102 in a conventional manner.

The first side assembly 14 may be shipped to the assembly unit as a complete unit and fastened to the chassis 15 of the vehicle 12 as a complete unit. The functional components associated with the first side assembly 14 (e.g., the battery 54, fuseblock 52, and ECM 56) may be included in their respective chambers prior to shipment for final assembly. In this manner, common fasteners (e.g., fasteners 15) can be used to secure multiple functional components. This compares favorably to the prior art which requires independent fastening of most functional components separately. After the functional components are mechanically secured to the vehicle 12, these functional components need only be functionally connected to the vehicle. For example, the batter 54 is simply connected to the appropriate wire harnesses (not shown). The second side assembly 28 is similarly shipped and secured within the vehicle 12.

While the invention has been described in the specification and illustrated in the drawings with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments illustrated by the drawings and described in the specification as the best mode presently contemplated for carrying out this invention.

1. A shared wall assembly for housing a plurality of functional components of a motor vehicle, the shared wall assembly comprising:
a main body portion partially defining first, second and third chambers, the main body portion including a first shared wall disposed between the first and second chambers and a second shared wall disposed between the second and third chambers; and
an upper unit for further defining at least two of the first, second and third chambers, the cover member removable attached to the main body portion.

2. The shared wall assembly for housing a plurality of functional components of a motor vehicle of claim 1, wherein the upper unit further defines each of the first, second and third chambers.

3. The shared wall assembly for housing a plurality of functional components of a motor vehicle of claim 1, wherein the first and second shared walls are perpendicular.

4. The shared wall assembly for housing a plurality of functional components of a motor vehicle of claim 1, wherein the upper unit includes an upper surface defining at least one generally planar surface.

5. The shared wall assembly for housing a plurality of functional components of a motor vehicle of claim 4 in combination with the vehicle, the shared wall assembly secured to a chassis of the vehicle.

6. The shared wall assembly for housing a plurality of functional components of a motor vehicle of claim 5, wherein the upper surface extends along a substantially portion of a length of an engine compartment of the vehicle.

7. The shared wall assembly for housing a plurality of functional components of a motor vehicle of claim 1, wherein the upper unit includes a downwardly extending portion terminating at a horizontal flange, the horizontal flange partially defining one of the first, second and third chambers.

8. An assembly for mounting in an engine compartment of a motor vehicle, the assembly comprising:
a lower unit including a first portion partially defining an air box and a second portion partially defining at least one chamber for receiving a functional component of the motor vehicle; and
a first cover for further defining the air box.

9. The assembly for mounting in an engine compartment of a motor vehicle, the assembly of claim 8, further comprising a second cover for further defining the at least one chamber.

10. The assembly for mounting in an engine compartment of a motor vehicle, the assembly of claim 8, wherein the first cover includes a tubular input.

11. The assembly for mounting in an engine compartment of a motor vehicle, the assembly of claim 8 in combination with the vehicle, the assembly secured to a chassis of the vehicle.

12. An underhood mounting system for mounting a plurality of underhood components including a battery to a motor vehicle body, the underhood mounting system comprising:
an integrally formed receiver member defining a plurality of dedicated locations for receiving a corresponding plurality of underhood components, the receiver member for attachment to the body of the vehicle;
a first dedicated location of the plurality of dedicated locations defining a portion of a battery chamber; and
a cover member operable to cooperate with the first dedicated location to define a remainder of the battery chamber, the cover member defining a projection portion for engaging the battery and maintaining the battery in a secure relationship with the battery chamber in an assembled position.

13. The underhood mounting system of claim 12, wherein the cover member defines an upper portion for covering a top face of the battery and a forward portion for covering a forward face of the battery, the forward portion incorporating the projection portion thereon.

14. The underhood mounting system of claim 13, further comprising a coupling member, the coupling member adapted to selectively secure the cover member to the first dedicated location of the receiver member.

15. The underhood mounting system of claim 14, wherein the coupling member is operable to locate the cover member in a position relative to the first dedicated location of the receiver member whereby the projection portion is influenced into the battery for maintaining the battery in the secure relationship with the battery chamber.

16. The underhood mounting system of claim 15, wherein the projection portion is in the form of a wedge.

17. The underhood mounting system of claim 13, wherein the upper portion includes removable insert portions for providing access to terminals extending from the top face of the battery.

18. The underhood mounting system of claim 15, further comprising a second dedicated location of the plurality of locations defining a receiving portion for accepting an engine control module.

19. The underhood mounting system of claim 17, further comprising a third dedicated location of the plurality of locations defining a receiving portion for accepting a fuseblock.

20. An underhood mounting system for a vehicle comprising:
an engine cover defining an opening on an upper surface, the opening providing access to a throttle body; and
a removable throttle body access cover covering the opening in an installed position.
